(19) United States
(12) Patent Application Publication
(10) Pub. No.: US 2009/0282695 A1
(43) Pub. Date: Nov. 19, 2009

(54) DRYER WITH DRYING SEQUENCE USING AN ADDITIVE

(75) Inventors: Uta Kreutzfeldt, Freystadt (DE); Thomas Loy, Nurnberg (DE); Johannes Sierl, Nurnberg (DE); Hans Joachim Klug, Winkelhaid (DE); Dieter Schmidt, Rothenbach (DE); Hansjorg Lampe, Nurnberg (DE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 12/299,244

(22) PCT Filed: Apr. 27, 2007
(86) PCT No.: PCT/EP2007/003762

§ 371 Date: Jun. 1, 2009

(30) Foreign Application Priority Data
May 2, 2006 (EP) 06 009 015.6
May 2, 2006 (EP) 06 009 016.4
Jun. 1, 2006 (EP) 06 011 420.4

(51) Int. Cl. F26B 3/00

(52) U.S. Cl. 34/443; 34/90

(57) ABSTRACT

The invention relates to a method of treating textiles in a dryer, in particular in an exhaust air and/or a condenser dryer or in a washing machine having a drying unit, wherein the method comprises at least one program sequence of supplying (S) at least one additive into a drum of the dryer, and within the at least one additive supplying sequence (S) changing the drum rotation direction and/or changing the air flow rate and/or air flow or fan rotation direction.

The invention relates to a method and an apparatus for treating textiles in a dryer, in particular exhaust air and/or condenser dryer or washing machine having a drying function, using a program sequence for supplying at least one additive to the laundry, wherein the air flow during the additive supplying sequence is reduced.

EP 1 441 060 A1 discloses a tumble dryer having one or two injection units arranged in proximity to the loading door of the dryer to inject an additive like water steam, a cleaning detergent, a fragrance or a disinfectant into the drum. It is proposed to reduce, stop or reverse the air flow through the drum to optimize the efficiency of the interaction between the injected additive and the laundry. For modifying the air flow, a fan is arranged in an air channel supplying drying air into the drum, wherein the fan is driven by a motor being separate from the driving motor of the drum under the independent control of a control unit.

It is an object of the invention to further improve the method of treating textiles during the additive supply and to provide a dryer having components adapted to at least partially reduce the air flow during the additive supply.

The invention is defined in claims 1, 17, 18 and 26, respectively.

Particular embodiments are set out in the dependent claims.

According to claim 1, a method is provided, in which—specifically during the supply of at least one additive into the drum of the dryer—the drum rotation direction is changed, preferably repeatedly changed during the supplying program sequence, and/or the air flow rate and/or the air flow direction are/is changed, preferably also the air flow rate or air flow direction is repeatedly or periodically changed during the supplying program sequence.

By changing the drum rotation direction during the supplying program sequence the laundry loaded into the drum is rearranged and redistributed within the drum, such that the likelihood of supplying the at least one additive onto each part of each of the textile pieces in the drum is increased. Even if the additive supplying sequence is short, for example only 1-2 minutes, two, three or more direction reversals during the supply sequence are sufficient to evenly distribute the additive to the laundry. The ratio of forward and reverse rotation times may be close to unity, or short periods of reverse or forward rotation may be interrupted by longer periods of forward or reverse rotation, respectively. For example, the ratio of forward to reverse rotation times may be in the range of 3-10 or 0.1-0.3, respectively. Such an intermittent drum rotation may be used independent of the type of dryer, for example condenser dryer, exhaust air dryer, and in dependency of whether the fan for generating the air flow is synchronously coupled to the motor of the drum or not (see also further embodiments below).

The change of the air flow direction during the supplying program sequence is induced by changing the rotation direction of a fan or blower. The change may be synchronized with the change of drum rotation (for example by using only one motor for driving the drum and the fan) or may be partially synchronized to the drum rotation or independent of the drum rotation. Changing the flow direction also improves the redistribution of the additive concentration within the drum. Changing the drum rotation direction and air flow direction is preferably combined, can however also be changed independent of each other during the supplying program sequence.

It was observed by the inventors that a change of the fan rotation direction does not immediately result in a change of the air flow direction, but that the air column being present in the drum, in the inlet and in the outlet channels is inertial, in particular in a condenser dryer where a condenser is additionally used. This means that after the start the fan has to operate some seconds before the air column starts moving into the desired direction or, if the fan rotation is reversed, it lasts some more seconds before the flow direction of the air column comes to a rest and begins to flow in the reverse direction. During such reversal periods or stop/start periods the effective or average flow rate is far below the nominal flow rate, which is achieved in an equilibrium after the fan is rotating in one direction, say for example for one minute. Therefore, in an embodiment it is proposed to provide forward and reverse rotation directions for the fan during the supplying program sequence, wherein in each of these periods the maximum flow rate achieved during this period is less than 70% of the nominal flow rate (which is the maximum flow rate in normal operation, i.e. the forward drying flow generated after a minute of operating the fan at nominal rotation speed). It is to be noted that, when the maximum flow rate in each of the periods is 70%, the average flow rate during these periods is even lower.

In an alternative or combined embodiment the volume exchange in the drum is observed, which is achieved during each of these forward and rotation periods, wherein during each of the rotation periods the volume flow going out of the drum is less than 50% of the drum's volume. Both solutions—individually or combined—have the effect that the additive supplied into the drum during the supplying program sequence is mainly maintained within the drum to provide maximum efficiency in interaction with the laundry. Thereby additive consumption is also reduced and additive removal (to the outside of the dryer in the case of an exhaust air dryer or into the condenser tank in case of a condenser type dryer) is reduced.

According to EP 1 441 060 A1, it is proposed to stop, reduce or reverse the air flow by stopping a separate motor driving the fan, reducing its rotation speed or reversing its rotation direction. According to an embodiment of the present invention, it is proposed to provide a throttling or rectifying means throttling or stopping the air flow through the drum when being actively or passively activated. The throttling or rectifying means can be arranged at any location in the air flow path connected to the drum. For example, it may be integrated in a fluff filter, in an air channel guiding air into the drum, or in an air channel guiding the air out of the drum. It may also be integrated in the condenser unit, however, preferably the throttling or rectifying means is integrated in an air channel and is preferably a passive element. However, the throttling or rectifying means can also be operated under the control of the control unit, for example using an actuator like an electromechanical magnet switch. In a preferred embodiment the throttling or rectifying means is combined with at least one shutter or deflection element provided to switch between exhaust air operation and circulation air operation of a switchable exhaust/condenser air dryer. When using a throttling or a rectifying means the air flow through the drum is at least partially and/or at least temporarily reduced or stopped thereby, such that for example the fan generating the air flow can be operated in forward and/or reverse direction and the air flow to be avoided or reduced during the supplying program sequence is stopped or reduced by the throttling or rectifying means.

The inventors also suggest to provide a fan or blower of specific characteristics, which results in different delivery rates for the air flow during forward or reverse rotation of the fan or blower when rotating at the same rotation speed. Using such a specific fan characteristic the time periods for forward and reverse rotation may be significantly different from each other, while the air volume exchange in the drum and/or the maximum air flow in each direction remains below the same threshold for each of the directions.

This effect of a reduced delivery rate of the fan for example in the reverse direction is used to reduce the air flow through the drum by reversing the rotation of the fan. Preferably, the drum is rotated synchronously with the rotation of the fan, which means that only one motor for driving the fan and the drum can be used. Here and in the following the term ‘synchronous rotation’ of the drum and fan does not mean rotation with the same speed, but with a predetermined gear transmission ratio at least in one direction (e.g. the fan rotates 20 times faster than the drum). Thus, only by temporarily reversing the drum rotation and fan rotation the flow rate is significantly reduced. In a further embodiment, which may be used alternatively or additionally to the above embodiments, a fan having a specific delivery rate characteristic in dependency of the fan rotation speed is used. This means that the delivery rate for generating the air flow is non-linearly dependent on the rotation speed and, when reducing the rotation speed from the nominal or maximum speed, the decrease in the delivery rate is much higher than the decrease in rotation speed. Preferably, a 20% reduction in rotation speed results in a reduction of the delivery rate of at least 40%, preferably by at least 55%. Thereby, also the air exchange in the drum is significantly reduced. The embodiments of the method can gradually be combined, for example, if there is a delivery rate reduction in reverse direction, the rotation speed in reverse direction can be higher than the rotation speed in the forward direction where the over-proportional delivery rate reduction is used with the reduction of rotation speed. It is to be noted that these embodiments are particularly convenient for dryers having a construction, in which a single motor drives the fan as well as the drum.

In a further embodiment the drum rotation speed and/or the air flow rate is adapted in dependency of the type and/or weight of the textiles loaded into the drum. If for example low volume or low weight laundry is loaded into the drum, the air distribution between the laundry and thereby the distribution of the at least one additive is sufficient to achieve high efficiency. If, however, high volume or high weight of laundry is loaded into the drum, the distribution of the additive supplied into the drum is hampered by the laundry, and therefore the distribution is improved by a reverse air flow or an intermittent air flow partially sucking the air out of the drum and reintroducing it after reversing the flow direction, such that additional agitation of the air column within the drum improves additive distribution to all areas of the laundry. This results in a tradeoff between efficiency of the additives (loss due to exhausting it out of the drum) and even distribution of the additive among the high volume laundry. Also, since the total time of supplying the at least one additive into the drum during the program sequence is relatively short (for example 1-3 minutes), it is preferred to optimize the tumbling of the laundry in the drum by adapting the drum rotation speed to the volume of the textiles or load of the textiles. For example, in case of a low volume of laundry the rotation speed of the drum is reduced to avoid a ring of textiles on the drum's circumference, while the drum rotation speed is increased and rotation direction changes are used to redistribute or tumble the laundry from the inner section to the outer section. As another example, reference is made to different types of textiles and to the application of hot water steam as at least one additive to the textiles where the refreshment effect is textiles-type-specific. For example silk fabrics may not be overheated by the hot steam and has only a short interaction period, such that there is an air flow maintained during the supplying program sequence to avoid overheating, while cotton textiles are less delicate to overheating, and it is preferred to stop the air flow for cotton textiles, which needs more steam for penetrating the cotton sheets.

Specifically, when changes of the rotation directions of the drum are used for redistributing the laundry and improving the homogeneity of additive treatment, and when at the same time the fan is rotated synchronously with the drum, the reverse rotation direction time is longer than the forward rotation direction time. For example, when the delivery rate of the fan is reduced in the reverse rotation direction, such unbalanced ratio of rotation directions reduces the air exchange in the drum and thereby the losses of the at least one additive.

In a preferred embodiment the treating method comprises at least two successive additive supplying sequences, in particular three or four additive supplying sequences. Providing several supplying sequences avoids overheating of the laundry, when for example steam is used as an additive, or the concentration of the additive (for example humidity) is limited to certain thresholds. Also different additives may be supplied during different additive supplying sequences and/or the processing parameters for each or some of the additive supplying sequences are changed. If for example the removal of odour should be improved in the first additive supplying sequence, all or a portion of the air within the drum can be exhausted to the outside (exhaust air dryer or combined exhaust/condense type dryer), such that the substances causing the odours are completely or significantly removed from the laundry and the dryer. Then, in the subsequent additive supplying sequences, the removal of air and thereby additive from the drum can be stopped or significantly reduced, such that the efficiency of the additive supply is improved. If also for example the wrinkles or creases removing effect of the additive supplying sequence should be improved, it is preferred to restart the additive supply at predefined starting conditions, which for example are re-established during the phases interrupting the period between two successive additive supplying sub-sequences. Preferably, in the time between, before or after the additive supplying sequence, a drying and/or cooling sequence is/are executed, which establish/es specific starting conditions for the additive supplying sequence or which conserve/s the effect of the additive supplying sequence. For example, the start humidity is reduced to a specific value before starting the additive supplying sequence, such that the efficiency of the at least one additive is not reduced due to high humidity of the laundry in the drum. Or the laundry is heated or cooled to a specific value optimized for the additive supplying sequence, i.e. by cooling down the laundry a temperature shock can be induced when supplying hot steam, which will improve the anti-crease effect. Also, after using hot steam during the additive supplying sub-sequence, the subsequent cooling and/or drying sequence remove/s hot air and humidity, such that the user can immediately remove the laundry with a desired final humidity (iron aid), when the subsequent cooling and/or drying sequence has/have been executed after the additive supplying sequence.

According to claim 17, a dryer having a control unit is provided, which controls an additive supplying device, a motor for rotating a drum and a driving unit for driving a fan, wherein the driving unit may comprise the motor for driving the drum. During the supplying sequence for supplying the additive into the drum, the control unit is adapted to control the motor drum rotation direction and/or the fan's rotation speed and/or direction. The effects and specific operation modes of controlling the rotation speeds and/or directions of the fan and/or drum are described above in connection with method claim 1 and its embodiments, and correspondingly apply here.

According to claim 18, a dryer is provided, in which a fan generates an air flow through the drum, and wherein the delivery rate of the fan is non-linearly depending on its rotation speed and/or the rotation direction, in particular non-linearly depending on the rotation speed of the driving unit driving the fan. As mentioned above, a fan having a non-linear delivery rate characteristic is used, such that for example the delivery rate in forward and reverse direction (at the same absolute value of the rotation speed) is different from each other and/or the delivery rate is decreasing disproportional with the decreasing rotation speed. Such a dryer solution is in particular useful to reduce costs in that the drum and the fan may be driven by a single motor, wherein an at least partial decoupling of flow rate through the drum and drum rotation speed is preferably effected by the non-linearity of the delivery rate of the fan.

In a preferred embodiment the driving unit comprises a disengaging or coupling means which couples or decouples the fan to or from the motor in dependency of the motor rotation state, i.e. the rotation speed and/or the rotation direction. For example, the disengaging means is a freewheel as for example used in a bicycle, which drives the fan only, when the motor runs in forward direction, while it decouples, when the motor or driving unit runs in the reverse direction. Alternatively or additionally, a clutch operated by centrifugal force is provided, which decouples the fan from the motor and/or changes the position of the fan blades, which also results in a reduction of the delivery rate or in a stop of the fan rotation.

According to claim 26, a further embodiment of a dryer is provided, which can be combined with the dryer described above or which has features of the dryer described above. According to this embodiment, an air flow throttling and/or rectifying means is/are arranged in or assigned to the air inlet and/or outlet passage/s circulating the air into and out of the drum. It is to be noted that the meaning ‘inlet’ and ‘outlet’ is here not restricted to letting the airflow in or out, but that ‘outlet’ is assigned to the loading opening of the drum, which is conventionally used as air outlet in dryers. The air flow throttling and/or rectifying means at least temporarily throttle/s or rectify/ies the air flow in one of the air passages and may be actively operated, for example using an actuator, or can be passively activated, for example by the air flow. Some of the embodiments are already described above in connection with the operation method.

Reference is made in detail to preferred embodiments of the invention, examples of which are illustrated in the accompanying drawings, which show:

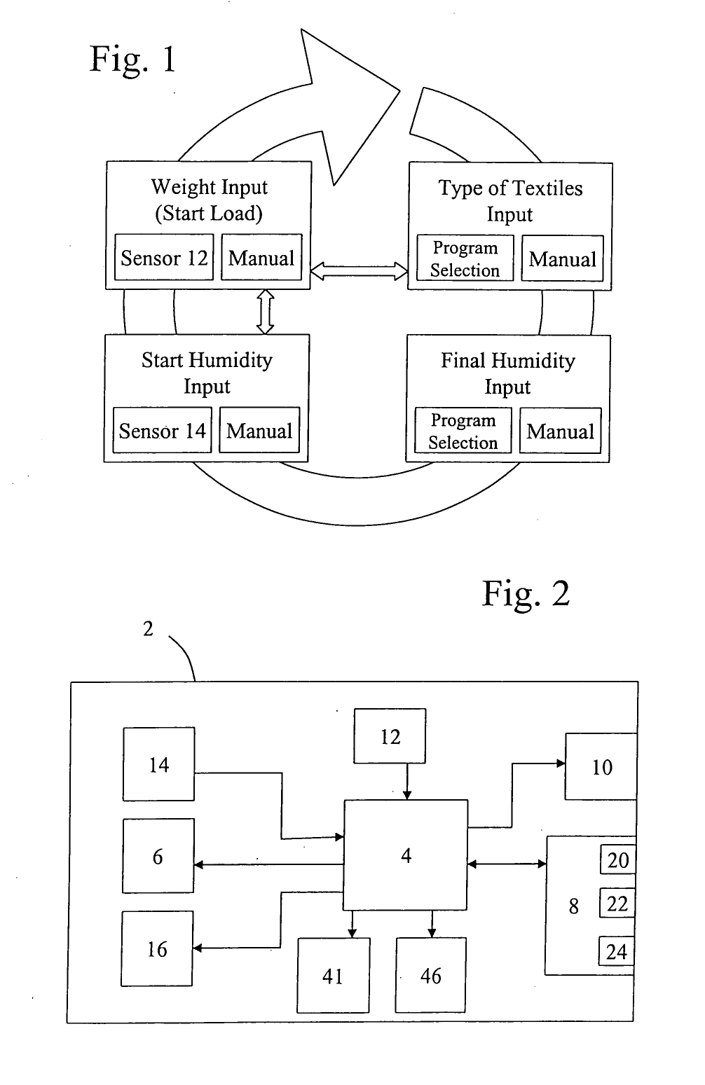

FIG. 1 a scheme of input program selections and program options,

FIG. 2 control elements of a dryer,

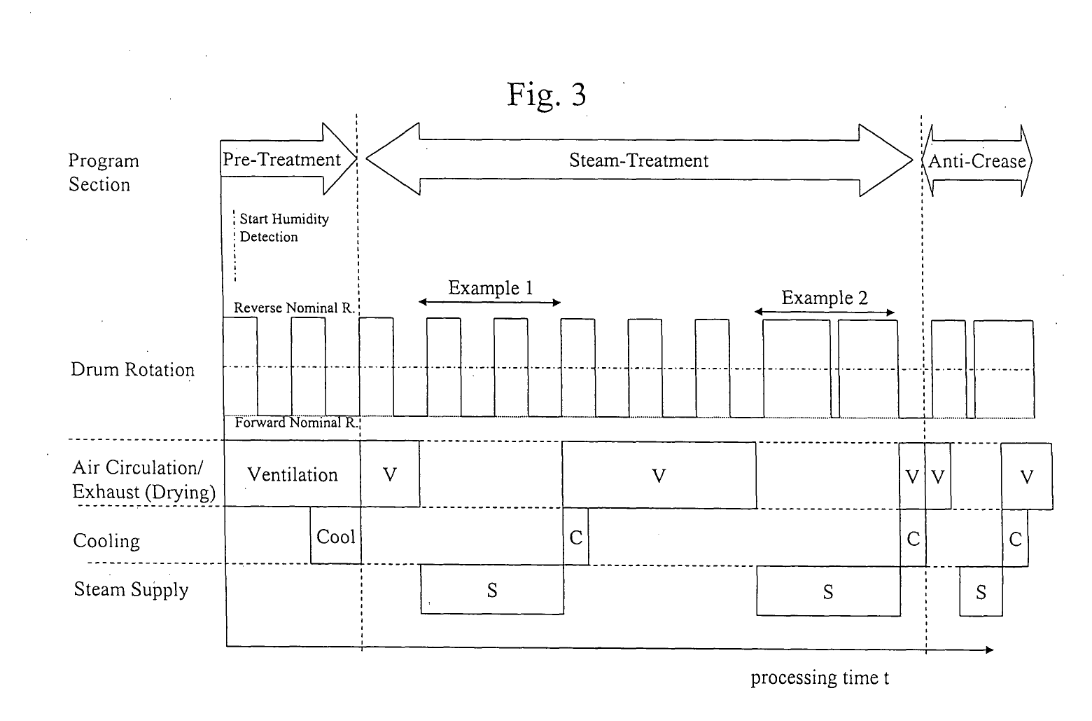

FIG. 3 a diagram depicting an exemplary program cycle including a steam-treatment sequence for cloth refreshment,

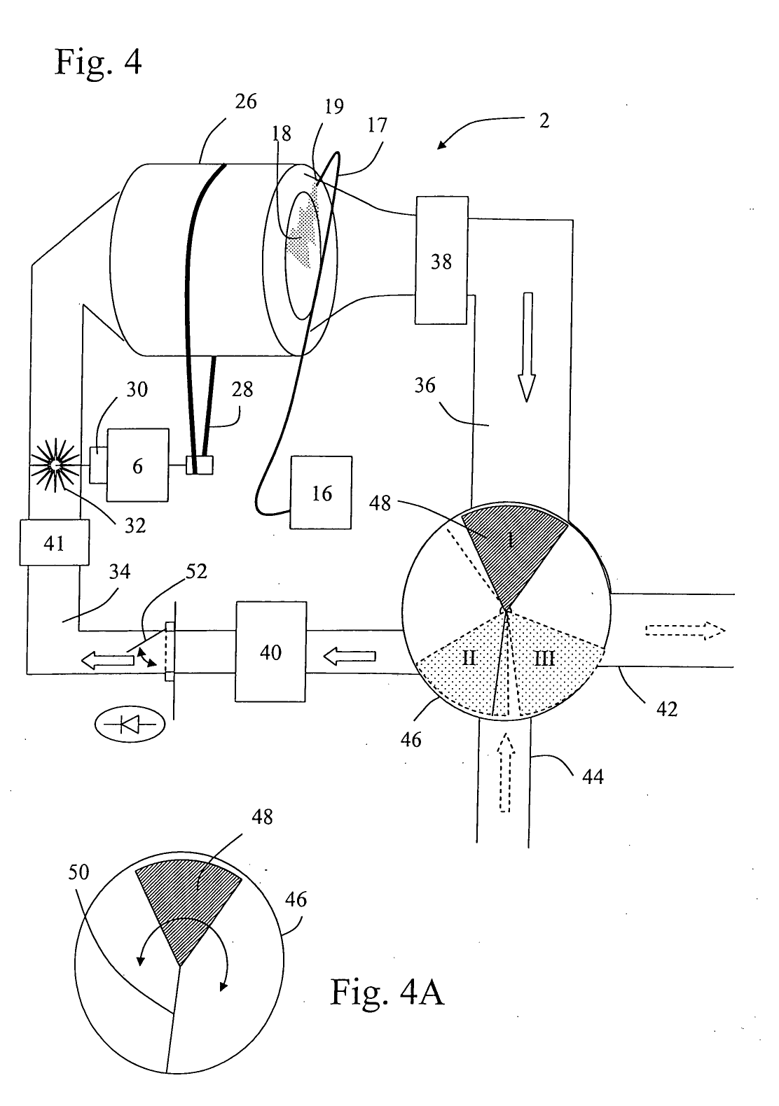

FIG. 4 air flow driving and guiding components of the dryer, and

FIG. 4A a detailed view of a flow valve.

FIG. 1 schematically shows the selection variety of available programs and program options to be selected by the user. Mandatory selections (program selection) and option selections (weight input, start humidity input, final humidity input) are shown. For running the exemplary dryer 2 of FIGS. 2 and 4 not all the optional user selections or the optional detection results have to be implemented. Preferably, the textile type and/or the weight input is implemented, since for example the amount of additive to be supplied onto the laundry depends on the laundry weight and/or the textile type. In the following exemplary embodiment all input types shown in FIG. 1 are described—while keeping in mind that these have not to be implemented in each or every case or in any model of the dryer. Some of the inputs are made prior to the starting of the program cycle (for example the program selection and textile type selection), while other inputs are made in the starting phase. For example, the start humidity may be determined by a humidity sensor 14 of the dryer 2, when the drying process has already been started. Preferably, the user selections and inputs are made prior to starting the drying cycle.

As indicated in FIG. 1, the input of the type of textiles (cotton, synthetics, wool, silk etc.) is made either by a program selection or manually by the user. If for example the user selected program is specific for the type of textiles, no separate input for the type of textiles has to be made by the user. If the program is not destined for a specific type of textiles, a corresponding input can be optionally requested from the user.

In the same way, the final humidity input for the final humidity of the laundry at the end of the drying cycle is either predetermined by a corresponding program selection or can optionally be input by the user. If for example a program is selected including an “iron aid” or “pre-ironing”, then the final humidity of the laundry is higher than in a program without such iron-specific determination. Optionally, the user may add this option to any of the drying programs by manually selecting this program option. Selection is made by pressing a button “iron aid”, which assists the subsequent ironing by a higher humidity of the laundry.

The starting humidity of the laundry may automatically be determined by the humidity sensor 14 in a starting phase of the drying sequence or may manually be input by the user. For example, the user input has the selections ‘wet’, ‘damp’ or ‘dry’.

The weight of the laundry loaded into the compartment of the dryer 2 can either automatically be determined by a weight sensor 12 or may be input by the user. For example, the user input is a weight selection like “high”, “medium” and “low”. Or it may be a drum volume input like “full”, “half full” and “few pieces”. If such load input by volume is made, the type of textiles can be considered to derive the actual weight of the laundry (see arrow between inputs ‘weight’ and ‘type’ in FIG. 1). Also when inputting the weight and the start humidity, the dry weight of the textiles can be deduced by subtracting the expected water weight using the humidity input (see arrow between inputs ‘start humidity’ and ‘type’ in FIG. 1). Of course, also the type of textiles can be considered to calculate the dry weight, which in turn is one of the factors to be included when determining an additive parameter like the amount of additive to be supplied to the laundry.

FIG. 2 shows principal elements of the tumble dryer 2 in a block diagram. The tumble dryer 2 is an electronically controlled program dryer, the program being executed and controlled by a central processing unit 4. The user interface of the dryer comprises a display section 10 and an input panel 8. The input panel 8 has a program selector 20 for selecting the main program, an inputting or indicator section 22 to input for example the type of textile, the weight and the start humidity, and an option selector 24 to select for example the “iron aid” and so on. The signals of the weight sensor 12 and the humidity sensor 14 are transmitted to the CPU for monitoring and controlling the drying process. Control signals are sent from the CPU 4 to a motor 6 driving a drum 26 (FIG. 4) and to an additive injector 16 to inject one or more additives via a supply pipe 17 and a nozzle 19 into the drum 26. The additive injector 16 comprises a water supply (water tank and pump) and a heater element operating under the control of the control device 4.

An exemplary user interaction with the user interface for the selection and options shown in FIG. 1 is now described: The display section 10 is a touch screen accepting user inputs by touching soft buttons displayed on the screen, which represent at least a portion of the input panel 8. As soon as the dryer is energized, the main programs to be selected by the user are shown on the display, and one of these main programs is selected. If a type of textiles is not determined by the main program selection, different types of textiles for selection are displayed. Thereafter, a selection for the loaded volume as described above is shown—thereby implementing an implicit weight selection. When the weight or load selection has been made, a start button is displayed at the same time with additional options like start humidity and final humidity option button, as mentioned above. These additional options can be activated by the user or can be skipped by starting the drying cycle with the start button. Instead of a touch screen, a turn selector in combination with a display and additional buttons for option selection may be provided.

Table I illustrates an example of a selectable drying program for cloth refreshment, in which auxiliary program sub-sequences are added to the main drying program sequences according to the program selection or option selection of the user (examples shown in FIG. 3). Due to the weight, start humidity and textile type input the duration of the sub-sequences are adapted, the end humidity of the laundry of the sub-sequences and the type and amount of additive to be applied to the laundry are adapted (if necessary, individually in each respective sub-sequence).

TABLE I
Basic Parameters of Program Sub-Sequences
of the Overall Drying Sequence

| | Auxiliary | Main Program | Auxiliary |
|---|---|---|---|
| | Program | Cloth Refreshment | Program |
| | Pre-Drying | Gas-Phase-Treatment | Anti-Crease |
| Program | duration | duration | duration |
| Sequence | | steam supply | |
| Parameter | | duration | |
| | | (textile-type- | |
| | | dependent) | |
| | start/end | (start/end | start/end |
| | humidity | humidity) | humidity |
| | | consumption/type of | consumption/type |
| | | additives | of additives |
| | | (textile-type- | |
| | | dependent) | |

In a preferred embodiment the dryer has one or more of the following selectable refreshment main programs: business refreshment, cotton refreshment, synthetic refreshment, synthetic shirt refreshment. The main features of these refreshment main programs are (in each the additive supply is scaled down or up, when not an average load (e.g. 1 jacket) is used, but either a lower load (e.g. 1 trouser) or a higher load (e.g. 1 suit) is used and input at the option selector):

### Business Refreshment:

Optimized for refreshing suits, trousers, jackets or costumes. Low additive supply amount (e.g. an average of 150 ml of water); short steam or additive injection time periods (e.g. 2 min); partial ventilation or air exhaust at least during the initial steam injection phase to remove smells; keeping the temperature during steam treatment or additive injection in the lower temperature range; anti-crease optimized ventilation and drum rotation.

### Cotton Refreshment:

Optimized for refreshing shirts or cotton fabrics. Medium additive supply amount (e.g. an average of 170-190 ml of water); medium steam or additive injection time periods (e.g. 2.5-3 min); keeping the temperature during steam treatment or additive injection in the medium temperature range.

### Synthetic Refreshment:

Optimized for refreshing synthetic fabrics. High additive supply amount (e.g. an average of 200-250 ml of water); upper steam or additive injection time periods (e.g. 3-4 min); keeping the temperature during steam treatment or additive injection in the upper temperature range.

### Synthetic Shirt Refreshment:

Optimized for refreshing synthetic fabrics. Medium-high additive supply amount (e.g. an average of 180-220 ml of water); upper steam or additive injection time periods (e.g. 3-4 min); keeping the temperature during steam treatment or additive injection in the upper temperature range; partial ventilation or air exhaust at least during the initial steam injection to remove smells; 3 to 4 steam treatment periods; anti-crease optimized ventilation and drum rotation (iron-free).

FIG. 3 shows a time diagram illustrating a typical main refreshment program including the steam treatment. Optionally, a pre-drying or pre-treatment is activated due to the selection or detection of a high initial humidity caused by laundry taken for example from a previous washing. In this case, a high start humidity is not compatible with the steam treatment requiring a lower degree of humidity of the laundry for starting the steam treatment. Another option selected by the user is an anti-crease phase following the refreshment sequence (steam-treatment) and preventing the generation of crinkles or creases in the laundry, when it is not immediately removed from the dryer's drum after finishing the refreshment program.

In FIG. 3 the program cycle starts with a ventilation phase, in which the start humidity and the start weight (optionally) of the laundry are determined by humidity sensor 14 and weight sensor 12. The ventilation phase includes a pre-drying phase (part of the ventilation phase by activating the heater and condensation and/or air exhaust), during which the start humidity is reduced. Optionally, a cooling phase C follows the pre-drying phase as a part of the ventilation phase V. During the cooling phase the temperature caused by the pre-drying is lowered to a start temperature optimized for starting the steam treatment. The ventilation phase V is followed by the steam treatment phase including the steam supply S, in which an additive is applied to the laundry via the additive injector 16. The last steam supply phase is followed by a ventilation phase V combined with a cooling phase C, in which no additive is supplied and which dries the laundry to the end humidity value given by the main program or to the value modified by the program option selected by the user. During this ventilation phase V, preferably including the cooling phase C at its beginning, the temperature of the laundry is reduced such that the treatment result achieved with the laundry during the steam treatment phase S is preserved, for example when removing the laundry from the dryer at the end of the steam treatment. Also the cooling phase acts as a safeguard to prevent the user from removing the laundry heated by the steam supply phase S from the dryer.

During the pre-treatment, the steam treatment and the anti-crease sequences the drum is agitated all the time in forward and reverse rotation direction, wherein the drum is driven with the forward nominal and reverse nominal speeds as shown (acceleration and deceleration phases are not shown for idealization). In dependency of the start humidity and/or program selection the pre-treatment sequence can be completely skipped and it can be started with the steam treatment sequence by a ventilation phase V. Two supply phases S are used during the steam treatment sequence, wherein the two steam supply phases S are interrupted by a ventilation phase V. The ventilation phase V is longer than the steam treatment phase S to cool down C the laundry and to remove the humidity supplied during the steam supply phase S. The drying of the laundry during the ventilation phase can be assisted by at least temporally heating the air flown into the drum 26 by the heater 41 (FIG. 4). As shown in FIG. 3, the last ventilation phase V during the steam treatment sequence can be longer to sufficiently remove the humidity introduced by the steam supply to the laundry. During both steam supply phases S the drum is agitated to tumble the laundry and to homogeneously distribute the supplied steam onto the laundry.

Two examples of drum agitation during the steam supply phases S are shown, namely example 1 and example 2. In example 1 the ratio between forward and reverse rotation periods is unitary. Such an exemplary drum rotation can be used with dryers having a separation between fan rotation and drum rotation (for example two motors as known from EP 1 441 060 A1), or the fan is decoupled from the motor driving the drum. In both cases, the ventilation V is interrupted during the steam supply phase S, and the steam introduced by nozzle 19 into drum 26 (see FIG. 4) is completely preserved within the drum's volume avoiding any loss of the steam jet 18. Example 2 refers to an embodiment of drum rotation, which is preferentially used in a dryer, in which the fan 32 is rigidly coupled to the motor 6 driving also drum 26, but in which the reverse delivery rate (delivery rate at reverse rotation of the motor with nominal speed) is significantly less than the delivery rate of the fan 32 when driven in nominal forward rotation direction. As shown in an idealized manner in FIG. 3, also in the steam supply phase S of example 2 the ventilation V (air flow) is zero. This is due to the fact that the drum rotates during the phase of example 2, predominantly in the reverse direction, and thereby the fan rotates in the reverse direction resulting in nearly zero air flow through the drum. Preferably, even in such an embodiment, drum rotation direction changes may be provided, however, the forward rotation periods are very short (only a few seconds), such that the inertia of the air column within the drum and the flowing channels results only in a minimal flow rate (not shown in FIG. 3 for idealization) and thereby minimal air exchange within the drum.

When the steam treatment sequence is finished, an anti-crease sequence may be optionally activated in dependency of the user selection and/or a pre-programming of the dryer's control unit 4. In the same way as the ventilation V is interrupted during the steam supply phases S of the steam treatment sequence, the air ventilation V is interrupted during the steam supply sequences S of the anti-crease sequence, i.e. separately driving the drum 26 and the fan 32, decoupling the fan 32 from the motor 6, providing a fan 32 having a significantly reduced reverse delivery rate or intermittently operating the fan, such that due to the inertia of the air column a very low absolute air flow through the drum 26 is generated.

FIG. 4 schematically shows air flow driving and guiding components of the dryer 2. For illustration purposes several components controlling the air flow are shown, at the same time keeping in mind that they can be provided in a real dryer either individually or in combination with one or more of the other air flow controlling elements. These air flow control elements shown are a freewheel 30 connecting the fan 32 to the motor 6, a fan 32 having a blade design causing a non-linearity of the air flow in dependency of the rotation speed and/or the rotation direction, a swing shutter 52 and a flow valve 46.

The motor 6 can be operated in forward and backward rotation direction, and drives the drum 26 via a belt 28. In a preferred embodiment the control unit 4 controls the motor 6 to rotate at least two different rotation speeds at least in one of the forward/reverse rotation direction, preferably the motor rotation speed of the fan is selectably controllable in a range of speeds. As shown, a freewheel 30 couples the fan 32 to the motor 6, wherein the fan 32 is only driven in forward rotation direction and is decoupled from the motor rotation in a reverse motor driving direction (like a freewheel of a bicycle). The fan is arranged in an inlet channel 34 guiding an airflow into the drum 26 in normal operation. The humidity detector 14 (not shown in FIG. 4) is integrated in the drum 26. The air flow through the drum 26 is output at the loading opening of the drum and guided through a fluff filter 38 into an outlet channel 36. In condenser type operation of the dryer the air from the outlet channel 36 is passed through a condenser 40 for condensing air humidity into the inlet channel 34. The air from the condenser 40 is entering a heater 41 heating the circulated air to improve the drying effect. A swing shutter 52 is arranged in the inlet channel 34, but may be also provided in the outlet channel 36, for example as part of the fluff filter 38. The swing shutter 52 opens in forward air flow direction and closes the air channel in a reverse flow direction or when stopping the air flow. Thereby, the swing shutter 52 has a rectifying effect, which prevents air circulation in the reverse direction. The shown example of the swing shutter 52 is operated by gravity, which means that the differential pressure in forward direction opens the shutter and—assisted by gravity—the shutter closes gradually, when the air flow is reduced and then stopped.

A guiding and switching valve 46 are connected to the inlet and outlet channels 34, 36 having a valve element 48 which may be swung or rotated under the control of the control unit 4 to the three positions I, II and III shown in FIG. 4. The valve housing is connected to an exhaust channel 42 and an intake channel 44, which connect the internal air circulation system to the outside air of the dryer. In dependency of the position of the valve element 48 fresh air is sucked into the air circulation system, and correspondingly humidity and air laden with exhaust fumes are exhausted through the exhaust channel 42.

FIG. 4A shows a detailed view of the valve 46 having the valve element 48. The valve element 48 is formed of a rotatable triangle (for example a hollow body having plates as side walls), wherein a plate 50 extends from the tip of the triangle. As shown in position I in FIG. 4, the triangle of the valve element 48 blocks the air flow from or to outlet channel 36, thereby blocking an airflow within the air circulation system, i.e. an air flow through drum 26. In position II of the valve element 48 the triangle in combination with plate 50 guides the air flow between the inlet channel 34 and the outlet channel 36 and vice versa. In position III of the valve element 48 the air flow from/to inlet channel 34 and outlet channel 36 is blocked and the outlet channel 36 is in communication with exhaust channel 42 and the inlet channel 34 is in communication with intake channel 44. Intermediate positions (not shown) are provided, in which circulating air is partially mixed with outside air for a combined condenser/exhaust air operation.

By using the freewheel 30 and/or the swing shutter 52 for a reverse rotation of the drum 26 or motor 6 the air flow is switched off and no air flows through the drum. The same applies, when valve 46 is used and valve element 48 is in position I, which prevents air flow within the air circulating system.

### REFERENCE NUMERAL LIST

2 tumble dryer
4 CPU
6 motor
8 input panel
10 display section
12 weight sensor
14 humidity sensor
16 additive injector
17 supply pipe
18 steam jet
19 nozzle
20 program selector
22 indicator section
24 option selector
26 drum
28 belt
30 freewheel
32 fan
34 inlet channel
36 outlet channel
38 fluff filter
40 condenser
41 heater
42 exhaust channel
44 intake channel
46 valve
48 valve element
50 plate
52 swing shutter

1. Method of treating textiles in a dryer (2), in particular exhaust air and/or condenser dryer or washing machine having a drying unit, the method comprising:
at least one program sequence of supplying (S) at least one additive into a drum (26) of the dryer (2), within the at least one additive supplying sequence (S):
changing the drum rotation direction and/or changing the air flow rate and/or air flow and/or fan rotation direction.

2. Method according to claim 1, comprising selecting the fan rotation time period in each of the forward and reverse rotation direction such that the final or maximal flow rate during each of the time periods is less than 70% of the nominal flow rate, preferably less than 50%, more preferably less than 30%.

3. Method according to claim 2, comprising selecting the fan rotation time period in each of the forward and reverse rotation direction such that the percentage of the air volume flowing out of the drum (2) during each of the time periods is less than 50% of the nominal flow rate, preferably less than 35%, more preferably less than 20%.

4. Method according to claim 1, comprising changing the air flow rate by throttling or stopping the air flow by a throttling or rectifying means (30, 46, 52).

5. Method according to claim 1, comprising changing the air flow rate by disengaging a fan (32) generating the air flow from a motor (6), in particular a motor (6) driving the drum (26).

6. Method according to claim 5, comprising changing the air flow rate by changing at least one blade position of a fan (32) generating the air flow.

7. Method according to claim 5, comprising at least temporally reversing the rotation direction of a fan (32) generating the air flow, thereby reducing the delivery rate of the fan by at least 50% as compared to the forward rotation direction using the same rotation speed, in particular reducing the delivery rate by at least 65%.

8. Method according to claim 5, comprising at least temporally reducing the rotation speed of a fan (32) generating the air flow by at least 20%, thereby reducing the delivery rate of the fan by at least 40%, in particular thereby reducing the delivery rate by at least 65%.

9. Method according to claim 5, comprising synchronously driving the drum (26) and a fan (32) generating the air flow at least in one direction.

10. Method according to claim 1, wherein the drum rotation speed, the drum rotation direction and/or the air flow rate are adapted in dependency of the type and/or weight of the textiles loaded into the drum (26).

11. Method according to claim 1, wherein the amount of additive supplied to the drum (26) and/or the duration of additive supply are/is adapted in dependency of the type and/or weight of the textiles loaded into the drum.

12. Method according to claim 1, wherein the additive is or comprises steam, in particular water steam, and/or is or comprises one or more of a cleaning detergent, a fragrance, a perfume, a disinfectant, or a bleach.

13. Method according to claim 1, wherein during the additive supplying sequence (S) the rotation direction of the drum (26) is changed at least once, preferably at least two, three or five times.

14. Method according to claim 13, wherein the ratio of forward rotation direction time to the reverse rotation direction time, in particular the ratio of consecutive forward/reverse periods, is less than 0.5, in particular less than 0.3, preferably less than 0.2.

15. Method according to claim 1, wherein the treating method comprises at least two successive additive supplying sequences (S), in particular at least two successive additive supplying sequences separated or intermitted by a ventilation phase (V).

16. Method according to claim 15, wherein a drying (V), heating and/or cooling (C) sequence are executed between at least two of the additive supplying sequences (S), before at least one of the additive supplying sequences (S) and/or after at least one of the additive supplying sequences (S).

17. Dryer (2), in particular exhaust air and/or condenser dryer or washing machine having a drying unit,
comprising:
a rotatable drum (26) comprising an air inlet (34) and an air outlet (36);
a motor (6) adapted to drive the rotatable drum (26);
a fan (32) for generating an air flow through the drum (26);
a driving unit (6, 30) adapted to drive the fan (32), wherein the driving unit of the fan may comprise the motor driving the drum;
at least one additive supplying device (16, 17, 19) each adapted to supply an additive into the drum (26); and a control unit (4) adapted to control at least one refreshment sequence, wherein the control unit is adapted to control the driving unit (6, 30), while the control unit is controlling at least one of the supplying devices (16, 17, 19) to supply the additive into the drum (26); characterized in that
during supplying (S) the additive into the drum, the control unit (4) is adapted to control the motor (6) of the drum (26) to change the direction of drum rotation and/or to control the driving unit (6, 30) of the fan (32) to vary the rotation speed and/or direction of the fan.

18. Dryer (2) comprising:
a rotatable drum (26) comprising an air inlet (34) and an air outlet (36);
a fan (32) for generating an air flow through the drum; and
a driving unit (6, 30) comprising a motor (6), the motor preferably adapted to synchronously drive the fan (32) and the rotatable drum (26) at least in one rotation direction;
wherein the delivery rate of the fan (32) is nonlinearly depending on the rotation speed, wherein the delivery rate is decreasing disproportionately to, decreasing rotation speed and/or the delivery rate of the forward rotation direction of the fan (32) is higher than the delivery rate in the reverse rotation direction of the fan.

19. Dryer according to claim 18, wherein the delivery rate in reverse rotation direction of the fan (32) is less than 50% of the delivery rate in forward direction, preferably less than 30%, more preferably less than 15% or 0%.

20. Dryer according to claim 18, wherein the delivery rate is reduced by more than 40% when the rotation speed, in particular the nominal or normal rotation speed, of the fan (32) is reduced by 20%, preferably by more than 50%, more preferably by more than 65%.

21. Dryer according to claim 18, wherein the driving unit (6, 30) further comprises a disengaging or coupling means (30) adapted to decouple the fan (32) from the motor (6) or to couple the fan to the motor in dependency of the motor rotation state, in particular in dependency of the rotation direction.

22. Dryer according to claim 21, wherein the disengaging or coupling means is a freewheel (30) and/or the degree or state of coupling of the fan (32) to the motor (6) depends on the centrifugal force provided by the motor rotation.

23. Dryer according to claim 21, wherein the disengaging or coupling means (30) comprises a clutch actuated by an actuator under the control of the control unit (4).

24. Dryer according to claim 18, wherein the position or alignment of at least one or all blades of the fan (32) is dependent on the rotation speed.

25. Dryer according to claim 24, wherein the position or alignment of the at least one blade is changed by the centrifugal force exerted by the fan's rotation.

26. Dryer (2) comprising:
a rotatable drum (26) comprising an air inlet and an air outlet;
an air inlet passage (34) connected to the air inlet and/or an air outlet passage (36) connected to the air outlet;
a fan (32) for generating an air flow through the drum (26);
a driving unit (6, 30) comprising a motor (6), the motor preferably adapted to synchronously drive the fan (32) and the rotatable drum (26) at least in one rotation direction;
an air flow throttling and/or rectifying means (30, 46, 52) arranged in or assigned to the air inlet and/or outlet passage (34, 36).

27. Dryer according to claim 26, wherein the throttling or rectifying degree of the throttling and/or rectifying means (30, 46, 52) is controlled by the control unit (4), the flow direction of the passing air and/or the flow rate of the passing air.

28. Dryer according to claim 27, wherein the throttling and/or rectifying means (46, 52) is at least one shutter or throttle arranged in or at the air inlet and/or outlet passages (34, 36).

29. Dryer according to claim 26, wherein the throttling and/or rectifying means (46) comprises at least one shutter or actuator element (48) adapted to partially or completely change between an exhaust air mode and an circulation air mode of the dryer (2).

30. Dryer according to claim 28, wherein the at least one shutter (52) is at least partially opened in a forward flow direction and at least partially closed in a reverse flow direction.
